(19) United States
(12) Patent Application Publication
(10) Pub. No.: US 2026/0292920 A1
(43) Pub. Date: Sep. 24, 2026

(54) METHOD AND DEVICE FOR CO-EXISTENCE OF NETWORK ENERGY SAVING (NES) MODE AND DISCONTINUOUS RECEPTION (DRX) IN WIRELESS COMMUNICATION SYSTEM

(71) Applicant: SAMSUNG ELECTRONICS CO., LTD., Suwon-si, Gyeonggi-do (KR)

(72) Inventors: Sangkyu BAEK, Suwon-si (KR); Anil AGIWAL, Suwon-si (KR); Sangjin KIM, Suwon-si (KR); Byounghoon JUNG, Suwon-si (KR)

(21) Appl. No.: 18/881,138

(22) PCT Filed: Jul. 6, 2023
(86) PCT No.: PCT/KR2023/009588

§ 371 Date: Jan. 3, 2025

(30) Foreign Application Priority Data
Jul. 6, 2022 (KR) 10-2022-0083128

(51) Int. Cl. H04W 76/28; H04W 52/02

(52) U.S. Cl. CPC H04W 76/28; H04W 52/0216

(57) ABSTRACT

The disclosure relates to a 5G or 6G communication system for supporting a higher data transmission rate. According to the present disclosure, efficient communication can be performed even when NES mode and DRX are set in order to lower the power consumption of a communication network.

### TECHNICAL FIELD

The disclosure relates to operations of terminals and base stations in a mobile communication system. Specifically, the disclosure relates to a specific control method for communication in the case that an NES mode and DRX are configured to reduce power consumption of a communication network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In the case that both an NES mode and DRX are configured to reduce power consumption of a communication network in a wireless communication system, the need for a specific method for performing communication has arisen.

### DISCLOSURE

### Technical Problem

In the case that both an NES mode and DRX are configured to reduce power consumption of a communication network in a wireless communication system, a specific method for performing communication is required.

### Technical Solution

According to an embodiment of the disclosure, a method performed by a terminal in a wireless communication system may include identifying whether a network energy saving (NES) operation for reducing power for a network and a discontinuous reception (DRX) operation for reducing power of the terminal are configured; determining, in the case that both the NES operation and the DRX operation are configured to the terminal, whether a network energy (NE) state is on/off based on the NES operation; and determining, in the case that the NE state is off, that DRX is in an inactive duration based on the DRX operation.

According to another embodiment of the disclosure, a method performed by a base station in a wireless communication system may include transmitting, to a plurality of terminals, a message for configuring a network energy saving (NES) operation for reducing power for a network in a group transmission manner; and transmitting a medium access control-control element (MAC CE) including bitmap information indicating whether a network energy (NE) state is on/off based on the NES operation, wherein in the case that both the NES operation and a discontinuous reception (DRX) operation for reducing power of the terminal are configured to the terminal, whether the NE state is on/off may be determined by the terminal based on the MAC CE, and in the case that the NE state is off, the terminal may determine that DRX is in an inactive duration based on the DRX operation.

According to another embodiment of the disclosure, a terminal in a wireless communication system may include a controller configured to control to identify whether a network energy saving (NES) operation for reducing power for a network and a discontinuous reception (DRX) operation for reducing power of the terminal are configured, to determine whether a network energy (NE) state is on/off based on the NES operation in the case that both the NES operation and the DRX operation are configured to the terminal, and to determine that DRX is in an inactive duration based on the DRX operation in the case that the NE state is off.

According to another embodiment of the disclosure, a base station in a wireless communication system may include a transceiver; and a controller configured to transmit, to a plurality of terminals, a message for configuring a network energy saving (NES) operation for reducing power for a network in a group transmission manner, and to control the transceiver to transmit a MAC CE including bitmap information indicating whether a network energy (NE) state is on/off based on the NES operation, wherein in the case that both the NES operation and a discontinuous reception (DRX) operation for reducing power of the terminal are configured to the terminal, whether the NE state is on/off may be determined by the terminal based on the MAC CE, and in the case that the NE state is off, the terminal may determine that DRX is in an inactive duration based on the DRX operation.

### Advantageous Effects

According to an embodiment of the disclosure, power consumption of a communication network can be efficiently reduced by configuring both an NES mode and DRX.

### DESCRIPTION OF DRAWINGS

FIG. 1 is a diagram illustrating a method of reducing power consumption of a network in a mobile communication system according to an embodiment of the disclosure.

FIG. 2 is a diagram illustrating an active time of a base station due to a DRX operation according to an embodiment of the disclosure.

FIG. 3 is a flowchart illustrating a method of applying DRX configuration values for each NES mode according to an embodiment of the disclosure.

FIG. 4 is a diagram illustrating an operation of applying DRX configuration values according to activation of an NES mode according to an embodiment of the disclosure.

FIG. 5 is a flowchart illustrating an operation of an NES mode according to an embodiment of the disclosure.

FIG. 6 is a flowchart illustrating an operation of DRX according to an embodiment of the disclosure.

FIG. 7 illustrates a NES mode activation MAC CE format according to an embodiment of the disclosure.

FIG. 8 illustrates a method of configuring an NES mode by group transmission according to an embodiment of the disclosure.

FIG. 9 is a flowchart illustrating an active time of DRX according to an embodiment of the disclosure.

FIG. 10 is a flowchart illustrating a method of applying DRX configuration information according to an embodiment of the disclosure.

FIG. 11 is a diagram illustrating a MAC timer operation method according to an embodiment of the disclosure.

FIG. 12 is a diagram illustrating a MAC timer operation method according to an embodiment of the disclosure.

FIG. 13 is a block diagram illustrating a structure of a base station according to an embodiment of the disclosure.

FIG. 14 is a block diagram illustrating a structure of a terminal according to an embodiment of the disclosure.

### MODE FOR DISCLOSURE

Hereinafter, an operating principle of the disclosure will be described in detail with reference to the accompanying drawings. In the following description, in describing the disclosure, in the case that it is determined that a detailed description of a related well-known function or constitution may unnecessarily obscure the gist of the disclosure, a detailed description thereof will be omitted. Terms described below are terms defined in consideration of functions in the disclosure, which may vary according to intentions or customs of users and operators. Therefore, the definition should be made based on the content throughout this specification.

Hereinafter, a term identifying an access node used in the description, a term indicating network entities, a term indicating messages, a term indicating an interface between network objects, a term indicating various identification information and the like are exemplified for convenience of description. Accordingly, the disclosure is not limited to the terms described below, and other terms indicating an object having an equivalent technical meaning may be used.

Hereinafter, a base station is a subject performing resource allocation of a terminal, and may be at least one of a gNode B, an eNode B, a node B, a base station (BS), a radio access unit, a base station controller, or a node on a network. The terminal may include a user equipment (UE), a mobile station (MS), a cellular phone, a smart phone, a computer, or a multimedia system capable of performing a communication function. In the disclosure, a downlink (DL) is a wireless transmission path of a signal transmitted from a base station to a terminal, and an uplink (UL) is a wireless transmission path of a signal transmitted from a terminal to a base station. Hereinafter, although LTE or LTE-A system may be described as an example, embodiments of the disclosure may be applied to other communication systems having a similar technical background or channel type. For example, 5G mobile communication technology (5G, new radio (NR)) developed after LTE-A may be included in a system to which an embodiment of the disclosure may be applied, and the following 5G may be a concept including existing LTE, LTE-A and other similar services. Further, the disclosure may be applied to other communication systems through some modifications within a range that does not significantly deviate from the scope of the disclosure by the determination of a person having skilled technical knowledge. In this case, it will be understood that each block of flowcharts and combinations of the flowcharts may be performed by computer program instructions.

Because these computer program instructions may be mounted in a processor of a general purpose computer, a special purpose computer, or other programmable data processing equipment, instructions performed by a processor of a computer or other programmable data processing equipment generate a means that performs functions described in the flowchart block(s). Because these computer program instructions may be stored in a computer usable or computer readable memory that may direct a computer or other programmable data processing equipment in order to implement a function in a particular manner, the instructions stored in the computer usable or computer readable memory may produce a production article containing instruction means for performing the function described in the flowchart block(s). Because the computer program instructions may be mounted on a computer or other programmable data processing equipment, a series of operation steps are performed on the computer or other programmable data processing equipment to generate a computer-executable process; thus, instructions for performing the computer or other programmable data processing equipment may provide steps for performing functions described in the flowchart block(s).

Further, each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function. In this case, a term ‘-unit’ used in this embodiment means software or hardware components such as a field programmable gate array (FPGA) or an application specific integrated circuit (ASIC), and ‘-unit’ may perform certain roles. However, ‘-unit’ is not limited to software or hardware. ‘-unit’ may be constituted to reside in an addressable storage medium or may be constituted to reproduce one or more processors. Therefore, as an example, ‘-unit’ includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and ‘-units’ may be combined into a smaller number of components and ‘-units’ or may be further separated into additional components and ‘-units’. Further, components and ‘-units’ may be implemented to reproduce one or more CPUs in a device or secure multimedia card. Further, in an embodiment, ‘-unit’ may include one or more processors.

Hereinafter, for convenience of description, the disclosure uses terms and names defined in 5GS and NR standards, which are the standards defined by the 3rd generation partnership project (3GPP) organization among currently existing communication standards. However, the disclosure is not limited by the terms and names, and may be equally applied to a wireless communication network conforming to other standards. For example, the disclosure may be applied to 3GPP 5GS/NR (5th generation mobile communication standard).

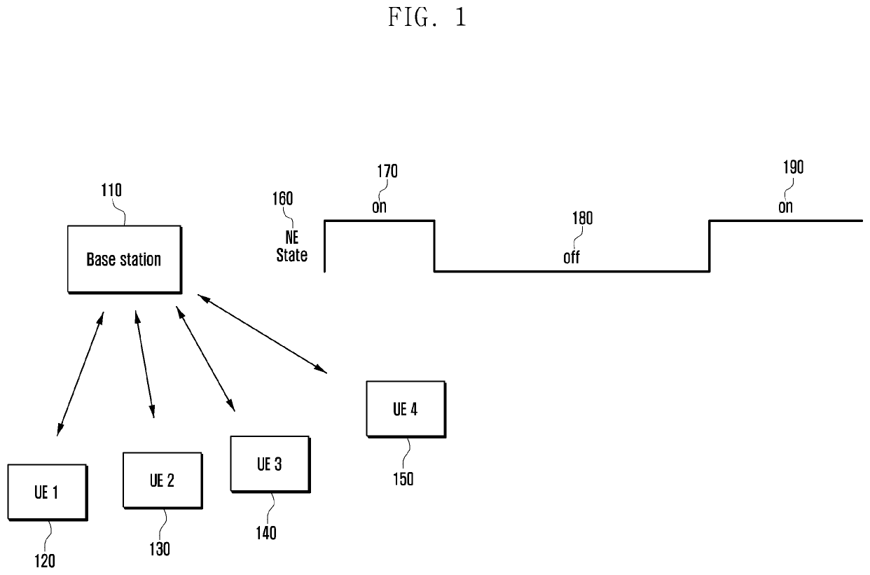

FIG. 1 is a diagram illustrating a method of reducing power consumption of a network in a mobile communication system according to an embodiment of the disclosure.

In a wireless communication system, a base station 110 provides a communication service to a plurality of UEs 120, 130, 140, and 150. In this case, each of the UEs 120, 130, 140, and 150 may be in a connected mode (RRC_CONNECTED mode) in which a radio resource control (RRC) connection is established, an inactive mode (RRC_INACTIVE mode) in which an RRC connection is released, or an idle mode (RRC_IDLE mode). UEs in various RRC modes may be located in coverage of one base station, and the base station 110 may provide a communication service to these plurality of UEs 120, 130, 140, and 150. Therefore, the base station 110 may have a relatively high power consumption amount compared to the UEs. Further, a fifth generation (5G) mobile communication system requiring high-speed transmission should have higher bandwidth, higher transmission signal strength, and higher reception sensitivity for high-speed transmission, which may lead to a high power consumption amount. Because the number of base stations managed by a single mobile communication operator is tens of thousands or hundreds of thousands, a high power consumption amount of a communication network including base stations may increase management and maintenance costs of the mobile communication network. Therefore, a method of reducing power consumption of the communication network is required.

Reduction of a power consumption amount of a communication network may be achieved by temporarily turning off power of a transceiver by the base station 110. Temporary turning off of power of the transceiver of the base station may be possible only when communication with a UE to which the base station 110 should provide a communication service is not performed. With reference to FIG. 1, a state when the base station 110 has turned off power of the transceiver is indicated as a network energy (NE) state (160). In the case that the NE state of the base station 110 is ON (170), the base station 110 may perform procedures necessary for transmission and reception to and from the UE in a state of turning on power of the transceiver. For example, the base station 110 may instruct resource allocation information on a physical downlink control channel (PDCCH) in order to allocate downlink resources to the UE and perform data transmission on a physical downlink shared channel (PDSCH). In another example, the base station may perform transmission and reception using downlink semi-persistent scheduling (SPS) or uplink configured grant (CG) resources, which are resources in which the base station periodically allocates to the UE. However, in the case that the base station 110 has no or little data to transmit and receive to and from the UE, the base station 110 may switch the NE state to OFF (180) and turn off power of the transceiver. In this case, in the case that the UE knows the NE state of the base station 110, the UE may also turn off power of the transceiver thereof to reduce power consumption and may not perform unnecessary communication procedures. The change of the NE state of the base station 110 may occur for a predefined time or may occur by separate control information. According to an embodiment, the NE state (160) of FIG. 1 illustrates switching back to an ON state (190) after a configured OFF state time (180).

The base station 110 may turn off all transceiver power in the NE OFF state (180), but in some embodiments, some transmission and reception functions of the base station 110 may be inactivated to obtain some of power consumption reduction effect. According to an embodiment, the base station 110 may periodically inactivate transmission of downlink SPS in which the base station transmits to the UE. For example, the base station 110 may inactivate transmission of downlink SPS in the NE OFF state. Further, according to an embodiment, the base station 110 may inactivate transmission of uplink CG in which the UE transmits to the base station 110; thus, the base station 110 may not receive CG in the NE OFF state. The base station 110 may transmit information on whether to inactivate some of transmission and reception functions to the UE, and the UE may not perform an operation corresponding to a function inactivated by the base station 110, thereby reducing unnecessary power consumption thereof and preventing malfunction thereof. An operation mode of the base station 110 and the UE for the NE OFF state of the base station 110 may be referred to as a network energy saving (NES) mode. In an embodiment, only an NE OFF state of the base station may be referred to as an NES mode. Although the detailed definition of the NES mode may vary according to the embodiment, a separate operation performed by the base station 110 and the UE in order to reduce power consumption of the base station 110 may be comprehensively referred to as an NES mode. The NES mode is a technique for reducing power consumption of the base station, and may be configured simultaneously with a discontinuous reception (DRX) technique, which is a method of reducing power consumption of the UE. In particular, a DRX method configured to a connected mode (RRC_CONNECTED) UE may be referred to as connected-DRX (C-DRX). In this case, inefficiency in UE operation may occur due to different purposes and detailed operations of the NES mode and DRX. Therefore, a method is needed to resolve inefficiency occurring when the NES mode and DRX are configured simultaneously.

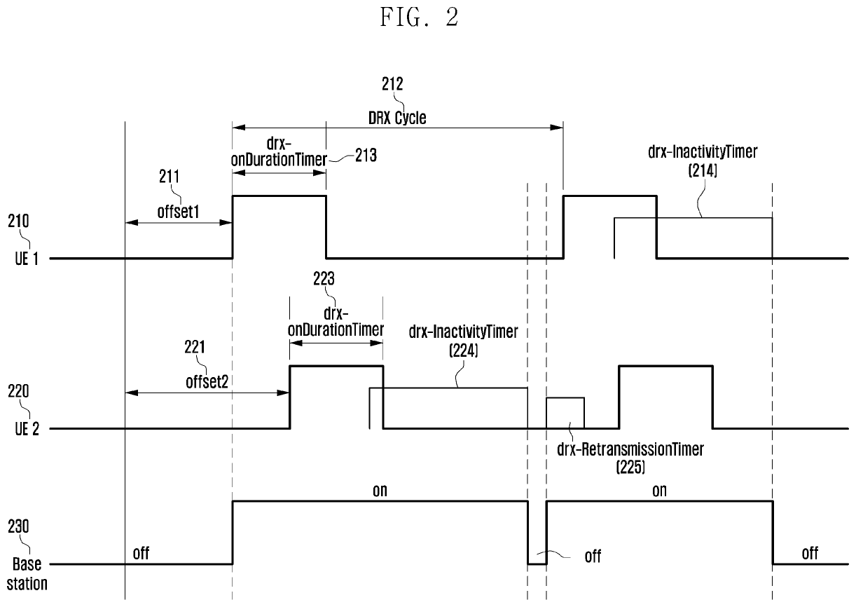

FIG. 2 is a diagram illustrating an active time of a base station due to a DRX operation according to an embodiment of the disclosure.

During a DRX (C-DRX) operation, the UE may intermittently monitor a physical downlink control channel (PDCCH), and while not performing PDCCH monitoring and uplink/downlink transmission based on the PDCCH, the UE may temporarily turn off power of the transceiver to reduce power consumption thereof. The time during which the UE performs PDCCH monitoring is referred to as an active time, and the condition of the active time may be defined as the time satisfying at least one of the following conditions.

Condition 1. A drx-onDurationTimer or drx-Inactivity Timer configured to a DRX group is running.

Condition 2. drx-Retransmission TimerDL, drx-Retransmission TimerUL or drx-Retransmission TimerSL is running.

Condition 3. A ra-ContentionResolution Timer or msgB-ResponseWindow is running

Condition 4. A scheduling request transmitting to a physical uplink control channel (PUCCH) remains in a pending state.

Condition 5. After successful reception of a random access preamble (RAR) for a physical random access channel (PRACH) preamble not selected by a MAC device of the UE, a PDCCH indicating initial transmission allocated with a C-RNTI has not yet been received.

During a DRX operation, each UE may have DRX configuration values thereof. Here, the DRX configuration values may include DRX offsets 211 and 221 (determined by drx-SlotOffset and drx-LongCycleStartOffset), a drx-onDuration Timer, drx-Inactivity Timer, drx-Retransmission Timer (drx-Retransmission TimerDL and drx-Retransmission TimerUL), a drx-HARQ-RTT-Timer (drx-HARQ-RTT-TimerDL and drx-HARQ-RTT-TimerUL), and a DRX cycle 212 (drx-ShortCycle and drx-LongCycle, in the example of FIG. 2, it is assumed that DRX cycles 212 of a UE 1 and a UE 2 have the same length). Due to DRX configuration values that may be configured differently for each UE, different UEs may have an active time at different times.

DRX (C-DRX) is an operation for reducing power consumption of a UE and is not an operation for reducing power consumption of a base station. In the case that the base station should perform a transmission and reception operation to and from at least one UE, the base station cannot turn off power of a transceiver. Therefore, as illustrated in the embodiment of FIG. 2, in an embodiment where only DRX is configured for the UE, only in the case that a DRX group of a plurality of UEs 210 and 220 is not in an active time, the base station 230 may temporarily turn off power of the transceiver. This temporary power turning off of the transceiver in a base station 230 may be similar to an NE OFF state. In the embodiment of FIG. 2, the state of the base station 230 indicated as “off” indicates a time when no UE is in an active time. A ratio of the time in the NE OFF state of the base station 230 may be small compared to the time when the UE is not in an active time. The reason why the NE OFF state of the base station 230 is short is because each UE 210 and 220 has a different DRX configuration value; thus, the base station 230 is likely to have to maintain the NE ON state in which the base station 230 turns on power of the transceiver and perform transmission and reception operations. Such a DRX operation may lead to inefficiency in power consumption of the base station. Therefore, a method of reducing power consumption of the base station is required, and for example, in the case that the base station performs an NES mode operation, a method may be required in which DRX configuration values of UEs are configured separately.

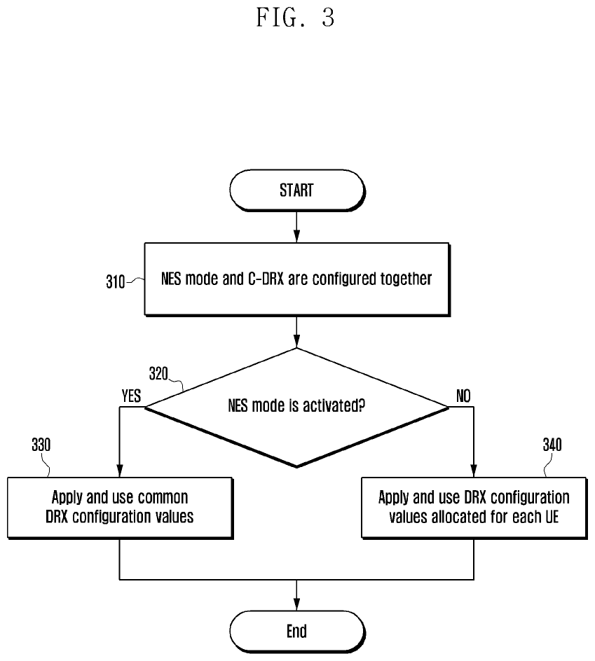

FIG. 3 is a flowchart illustrating a method of applying DRX configuration values for each NES mode according to an embodiment of the disclosure.

Because the NES mode is a technique for reducing power consumption of a base station and DRX is a technique for reducing power consumption of a UE, the two techniques may be configured and activated simultaneously. However, as described above, because a DRX operation may cause inefficiency in reducing power of the base station, DRX configuration information values applying when the NES mode is configured and activated may be different. The embodiment of FIG. 3 illustrates a method in which the UE separately has DRX configuration information values configured for each UE and DRX configuration information values commonly configured to a plurality of UEs for the NES mode. DRX configuration information values may include DRX offset (determined by drx-SlotOffset and drx-LongCycleStartOffset), a drx-onDurationTimer, drx-InactivityTimer, drx-RetransmissionTimer (drx-Retransmission TimerDL and drx-Retransmission TimerUL), a drx-HARQ-RTT-Timer (drx-HARQ-RTT-TimerDL and drx-HARQ-RTT-TimerUL), and a DRX cycle (drx-ShortCycle and drx-LongCycle). Some of these DRX configuration information values may be commonly used regardless of the NES mode, but some DRX configuration information values may be separately configured as DRX configuration information values applying when the NES mode is activated (in some embodiments, when the NES mode is configured) and DRX configuration information values applying when the NES mode is not activated (in some embodiments, when the NES mode is not configured). The DRX configuration information value applying when the NES mode is activated (in some embodiments, when the NES mode is configured) may be transmitted from the base station to the UE by at least one of an RRC message, a system information block, or a group scheduling message (group transmission using a group-RNTI (G-RNTI)). The DRX configuration information value applying when the NES mode is not in an active state (in some embodiments, when the NES mode is not configured) may be transmitted from the base station to the UE by an RRC message transmitting from the base station to the UE. In the case that the DRX configuration information value applying when the NES mode is activated is not separately configured, the UE may apply the DRX information value allocated for each UE when the NES mode in which the base station transmits to the UE is not activated.

In the embodiment of FIG. 3, it is assumed that the NES mode and C-DRX are configured together to one UE (310). The NES mode may be configured by the base station to a plurality of UEs. The configuration of the NES mode may be transmitted from the base station to the UE by at least one of an RRC message, a system information block, or a group scheduling message. DRX (C-DRX) may be configured by the base station to the UE by an RRC message. The NES mode may be activated or inactivated by the base station, and activation and inactivation of the NES mode may be indicated by the base station to the UE by one of an RRC message, a medium access control-control element (MAC CE), or a downlink control information (DCI) message transmitted to a PDCCH. Which DRX configuration value the UE uses may vary according to whether the NES mode is activated at each time point (320). For example, at step 320, the UE may determine whether the NES mode is activated at any time point. If the NES mode is in an active state, the UE may apply and use common DRX configuration values configured to a plurality of UEs (330). In the case that the NES mode is not in an active state, the UE may apply and use DRX configuration values allocated for each UE (340).

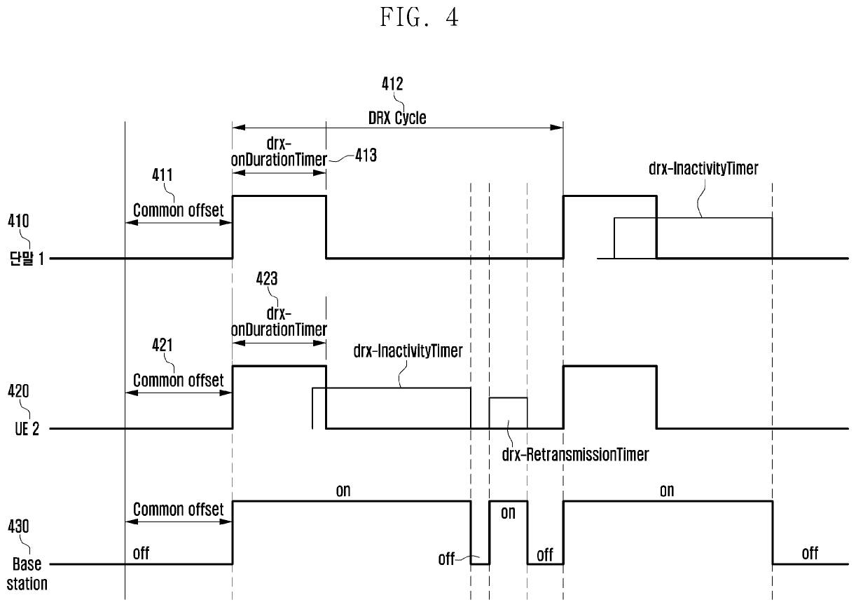

FIG. 4 is a diagram illustrating an operation of applying DRX configuration values according to activation of an NES mode according to an embodiment of the disclosure.

As described with reference to FIG. 3, when the base station activates the NES mode, the UE may apply and use common DRX configuration values to be used when activating the NES mode configured by the base station to the plurality of UEs. In the embodiment of FIG. 4, it is assumed that DRX offset indicated by common offsets 411 and 421 and a DRX cycle 412 (assuming the same value for a UE 1 and a UE 2) are commonly used by the UEs when activating the NES mode. However, parameters of commonly used DRX configuration values may be different according to the embodiment. In the case that the DRX offset is commonly applied, a plurality of UEs using the common offset may start drx-onDuration Timers 413 and 423 at the same time point of the common offset. The plurality of UEs starting the drx-onDurationTimers 413 and 423 may increase the possibility that the base station may go into the NE OFF state, which temporarily turns off power of the transceiver at different time points. Likewise, even in the case of the DRX cycle, because a plurality of UEs commonly have a cycle for changing to an active time, from a viewpoint of the base station, there is an advantage that the number of operations changing to an NE ON state due to an active time of some UEs may be reduced. As illustrated in the embodiment of FIG. 4 in this way, when the NES mode is activated, applying a common DRX configuration value to the UE may increase power consumption efficiency of an NES mode operation of the base station. A DRX configuration information value to be used when the NES mode is activated (when the NES mode is configured in some embodiments) may be transmitted from the base station to the UE by at least one of an RRC message, a system information block, or a group scheduling message.

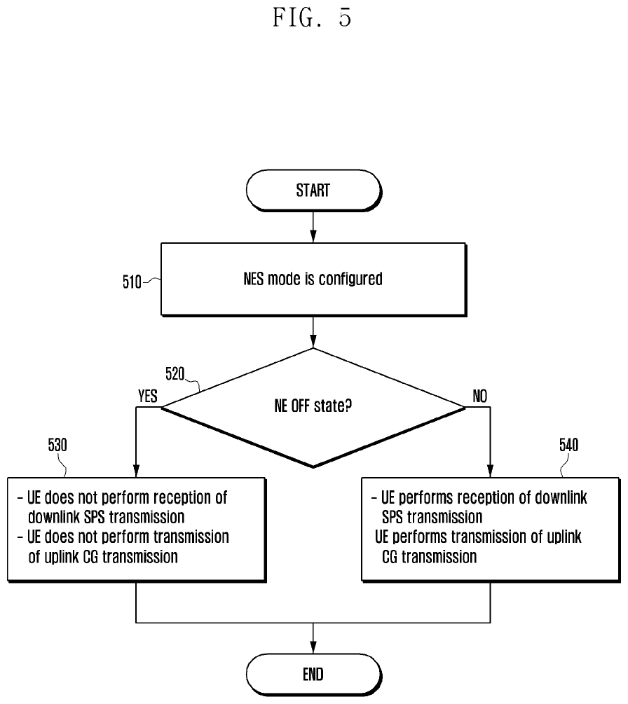

FIG. 5 is a flowchart illustrating an operation of an NES mode according to an embodiment of the disclosure.

The NES mode is a technique for reducing power consumption of a base station. When the NES mode is operated, the base station may perform an operation of changing between an NE OFF state that turns off power of the transceiver and an NE ON state that turns on power of the transceiver and that performs transmission and reception operations. Configuration information of the NES mode may be transmitted from the base station to the UE by an RRC message or a system information block. The UE may configure the NES mode based on configuration information of the NES mode included in the system information block or the received RRC message. The base station may determine activation of the NES mode by a low traffic amount, a small number of UEs in a cell, and the like, and the activation of the NES mode may be instructed from the base station to the UE by at least one of an RRC message, a MAC CE, a system information block, or a group scheduling message (group transmission using a group-RNTI (G-RNTI)), and the UE may apply activation of the NES mode. In the embodiment of FIG. 5, it is assumed that the NES mode is configured to the UE and activated (510). In this case, the UE may identify whether the status of the base station is an NE OFF state (520). In some embodiments, NE OFF of the base station may mean not an active time of the NES mode from a viewpoint of the UE. In other embodiments, another term may be used from a viewpoint of the UE for the NE OFF state. In the NE OFF state, the UE may not perform reception of configured downlink SPS transmission. In the NE OFF state, the UE may not perform transmission of configured uplink CG transmission (530). In this case, the base station does not perform transmission of downlink SPS transmission and does not perform reception of uplink CG transmission, thereby temporarily turning off power of the transceiver thereof to obtain the effect of reducing power consumption. In some embodiments, in the NE OFF state, the UE may not perform aperiodic CSI transmission, SRS transmission, SR transmission, and transmission of HARQ feedback (transmission of HARQ codebook) in which the UE transmits to a physical uplink control channel (PUCCH). As a result of determination at step 520, if the base station is not in an NE OFF state, for example, if the base station is in an NE ON state or if the state of the UE corresponds to an NE ON state, the UE may perform reception of configured downlink SPS transmission. If the base station is in an NE ON state (if the state of the UE corresponds to the NE ON state), the UE may perform transmission of configured uplink CG transmission (540). In this case, the base station may perform transmission of downlink SPS transmission and reception of uplink CG transmission.

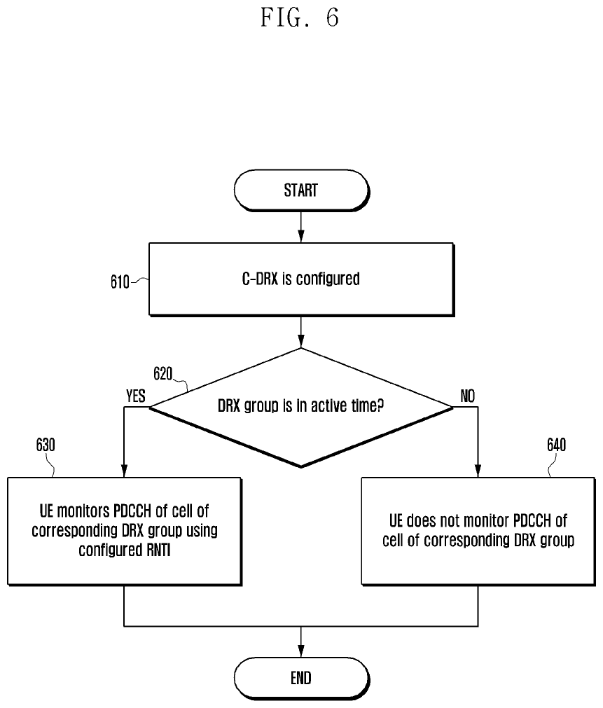

FIG. 6 is a flowchart illustrating an operation of DRX according to an embodiment of the disclosure.

DRX (C-DRX) is a technique for reducing power consumption of a connected mode UE. When DRX is configured to the UE, the UE may perform an operation of changing between an inactive time duration in which PDCCH monitoring is not performed and an active time duration in which PDCCH monitoring is performed. DRX configuration information is transmitted from the base station to the UE by an RRC message; thus, the UE may configure DRX. The base station may determine a configuration of DRX based on a traffic amount of the UE, remaining power amount information of the UE, and the like. In the embodiment of FIG. 6, it is assumed that DRX is configured and activated to the UE (610). In this case, the UE may identify whether a DRX group of each cell is in an active time (620). If the DRX group is in an active time, the UE may monitor a PDCCH of the cell of the corresponding DRX group using a configured RNTI (630). To this end, the UE may turn on power of the transceiver thereof, monitor the PDCCH, and perform a transmission and reception operation according to the PDCCH monitoring result. At step 620, if the DRX group is not in an active time, the UE does not need to monitor the PDCCH of the corresponding DRX group; thus, the UE may not monitor a PDCCH of the corresponding DRX group (640). In this case, the UE may perform an operation of temporarily turning off power of the transceiver and reducing power consumption. However, reception of downlink SPS transmission and transmission of uplink CG transmission may need to be performed even in the active time of the DRX group. In the case that the NES mode is configured and activated and is in the NE OFF state, reception of downlink SPS transmission and transmission of uplink CG transmission may not be performed. In this way, DRX may be used for controlling PDCCH monitoring of the UE, and the NES mode may be used for controlling other operations of the UE for reducing power consumption of the base station.

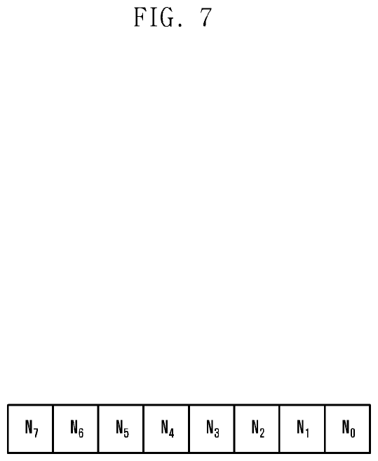

FIG. 7 illustrates a NES mode activation MAC CE format according to an embodiment of the disclosure.

The change between an NE OFF state and an NE on state of the base station or the UE due to power off of the transceiver of the base station may be configured and operated for each configured cell of the UE. In other words, the NES mode of the UE may be configured and activated for each cell. To this end, the base station may instruct the UE to activate the NES mode for each cell in a MAC CE format.

In the embodiment of FIG. 7, it is assumed that the base station instructs NES mode activation in the MAC CE format including a bitmap. In the embodiment of FIG. 7, an 8-bit length message was assumed, but the number of actual bits may vary according to the embodiment. A Ni bit (i=0, 1, 2, 3, 4, 5, 6, 7) of each of MAC CEs may indicate whether the NES mode was activated in a cell of an index i. According to an embodiment, in the case that a value of the Ni bit is 1, it may indicate activation of the NES mode, and in the case that a value of the Ni bit is 0, it may indicate inactivation of the NES mode (or that the NES mode is not activated). For example, in the case that the NES mode is activated for the cell of the index i, a value of the Ni bit may be configured to 1, and in the case that the NES mode is inactivated (or that the NES mode is not activated), a value of the Ni bit may be configured to 0. An index i value of Ni may use a cell index value. The disclosure is not limited to the above example, and the base station may define the index i value of the MAC CE for activating the NES mode as a separate index value corresponding to one cell and configure it to the UE by an RRC message.

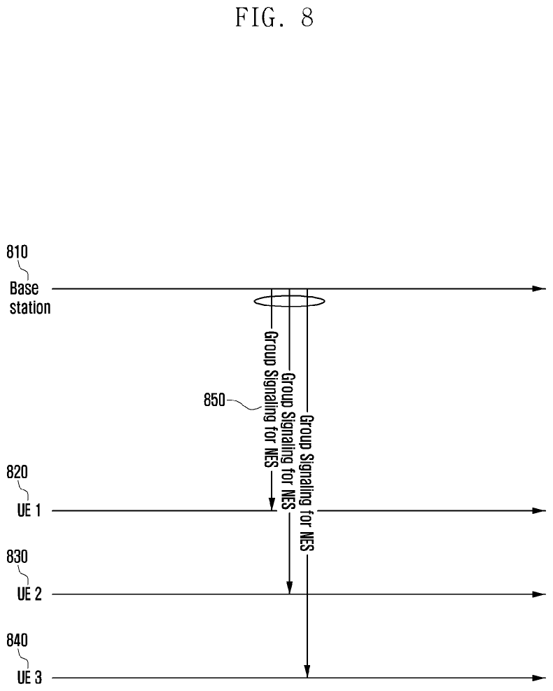

FIG. 8 illustrates a method of configuring an NES mode by group transmission according to an embodiment of the disclosure.

Because the base station usually provides a communication service to a plurality of UEs, in the case that the NES mode is configured to the plurality of UEs connected to a cell (or BWP) operated by the base station, the base station may turn off power of the transceiver to reduce power consumption. Therefore, the base station may configure the NES mode to the plurality of UEs at the same time point or at a similar time point (within a predetermined period from a predetermined time point). Accordingly, the base station may transmit an instruction to configure or activate the NES mode to the plurality of UEs in a multicast or broadcast format.

The embodiment of FIG. 8 illustrates that a base station 810 performs group transmission (850) in order to configure a NES mode to a plurality of UEs 820, 830, and 840 connected thereto. A group transmission manner may be to transmit through a system information block (SIB) or a group radio network temporary identifier (RNTI) commonly given to a plurality of UEs. The UEs connected to the base station may receive the configuration of the NES mode through group transmission and then apply the configuration of the NES mode to operate in the NES mode. According to an embodiment, operating in the NES mode may mean an operation in which the UE changes between the NE OFF state and the NE ON state described above according to a rule. Further, in order to activate or inactivate the NES mode, the base station may transmit a message instructing the UE to activate or inactivate the NES mode by using the group transmission manner of step 850.

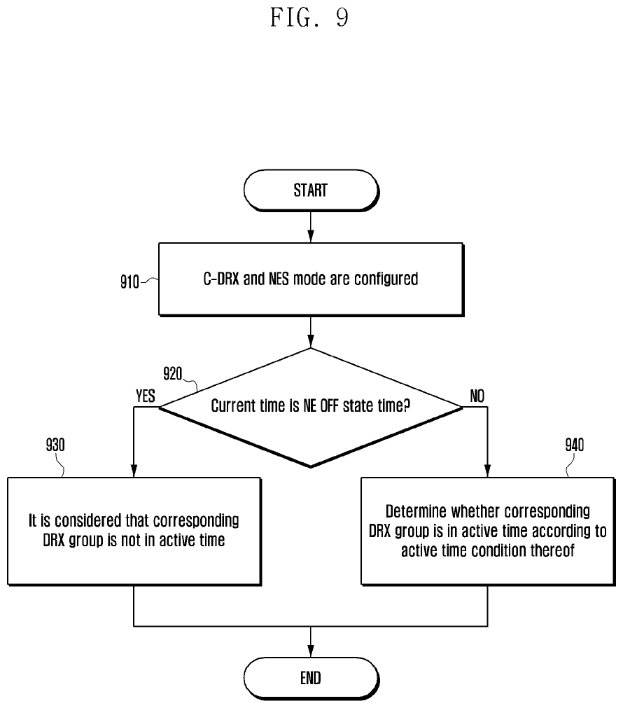

FIG. 9 is a flowchart illustrating an active time of DRX according to an embodiment of the disclosure.

During a DRX (C-DRX) operation, the UE may intermittently monitor a physical downlink control channel (PDCCH), and while not performing PDCCH monitoring and resulting uplink/downlink transmission, the UE may temporarily turn off power of the transceiver to reduce power consumption thereof. The time during which the UE performs PDCCH monitoring is referred to as an active time, and the condition of the active time may be defined as the time satisfying at least one of the following conditions.

Condition 1. A drx-onDurationTimer or drx-Inactivity Timer configured to a DRX group is running.

Condition 2. drx-RetransmissionTimerDL, drx-RetransmissionTimerUL, or drx-Retransmission TimerSL is running.

Condition 3. A ra-ContentionResolutionTimer or msgB-ResponseWindow is running

Condition 4. A scheduling request transmitting to a physical uplink control channel (PUCCH) remains in a pending state.

Condition 5. After successful reception of a random access preamble (RAR) for a physical random access channel (PRACH) preamble not selected by a MAC device of the UE, a PDCCH indicating initial transmission allocated with a C-RNTI has not yet been received.

In the case that the NES mode is configured, because it is assumed that the base station turns off power of the transceiver in the NE OFF state of the NES mode, the base station may not perform transmission and reception operations even if the active time of DRX satisfies at least one of conditions from the condition 1 to the condition 5. In this case, the UE may not need to perform PDCCH monitoring requiring in the active time.

The UE may identify whether DRX and/or the NES mode is configured. In the embodiment of FIG. 9, it is assumed that DRX and the NES mode are configured at the same time in the UE (910). In this case, the UE may identify whether the base station is in an NE OFF state (920). If the base station is in an NE OFF state, the UE does not need to perform a DRX active time operation. Accordingly, it is considered that the corresponding DRX group is not in an active time, and the UE may perform an operation when the corresponding DRX group is not in an active time (930). For example, the UE does not need to perform PDCCH monitoring, and in this case, the UE may perform an operation of reducing power consumption by turning off power of the transceiver of the UE.

At step 920, if the base station is not in an NE OFF state, the UE may determine whether the corresponding DRX group is in an active time according to the active time condition thereof (940). According to an embodiment, the base station may be in an NE ON state in which power of the transceiver is not turned off. In this case, the UE may determine whether the corresponding DRX group is in an active time based on the DRX operation. For example, in the case that at least one of conditions from the condition 1 to the condition 5 is satisfied, it may be considered as the active time and PDCCH monitoring may be performed. In the case that all of conditions from the condition 1 to the condition 5 are satisfied, it may be considered as not the active time. The embodiment of FIG. 9 is a method of not performing PDCCH monitoring regardless of the DRX operation in the case of an NE OFF state of the NES mode, which may have the effect of preventing unnecessary PDCCH monitoring of the UE in a situation in which power of the transceiver of the base station is temporarily turned off.

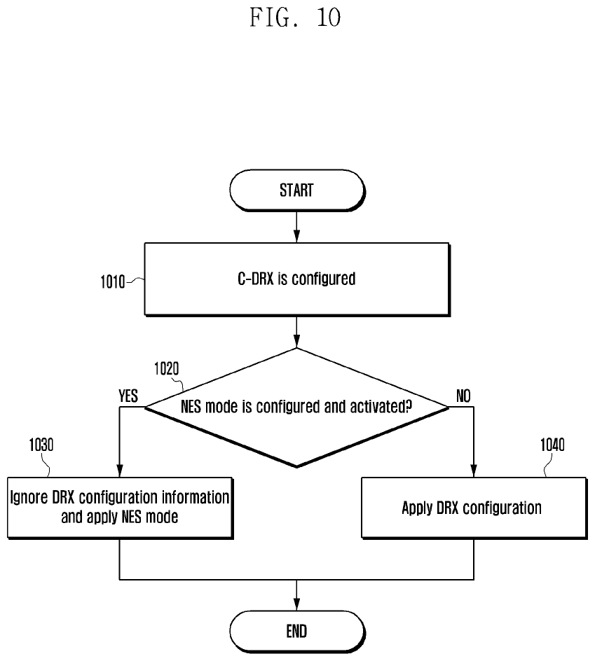

FIG. 10 is a flowchart illustrating a method of applying DRX configuration information according to an embodiment of the disclosure.

During a DRX (C-DRX) operation, the UE may intermittently monitor a physical downlink control channel (PDCCH), and while not performing PDCCH monitoring and resulting uplink/downlink transmission, the UE temporarily turns off power of the transceiver to reduce power consumption thereof. However, because the DRX operation has DRX configuration information for each UE, efficiency of power consumption reduction of the base station may be low. Therefore, in terms of reducing power consumption of the base station, it may be unnecessary that the UE performs the DRX operation.

In the case that the NES mode is configured, because it is assumed that the base station turns off power of the transceiver in an NE OFF state of the NES mode, the UE may also turn off power of the transceiver in the NE OFF state to reduce power consumption. Therefore, in the NE OFF state, the UE may not need to perform PDCCH monitoring as well as data transmission and reception operations. In the embodiment of FIG. 10, it is assumed that DRX is configured in the UE (1010). The state of the UE at step 1010 may mean a state in which the UE has received DRX configuration information from the base station. In this case, the UE may identify whether the NES mode of the base station is configured and activated (1020). In some embodiments, if the UE should perform an operation of the NES mode when the NES mode is configured without a separate activation procedure, the configuration of the NES mode may mean activation. If the NES mode is configured and activated, the UE may ignore DRX configuration information configured to the UE and apply configuration information of the NES mode to perform an NES mode operation (1030). For example, the UE may not apply DRX configuration information such as a DRX cycle. In another embodiment, the UE may follow the operation of the NES mode regardless of the DRX active time condition. If the NES mode is not configured and activated at step 1020, the UE may apply the configured DRX configuration information to perform the DRX operation (1040). For example, the UE may perform an operation corresponding to an active time and an inactive time according to the DRX configuration information.

In this case, in the case that the NES mode and DRX are configured at the same time, the UE may give a priority to the NES mode to perform the NES mode operation and not to perform the DRX operation, thereby increasing the effect of power consumption reduction of the base station.

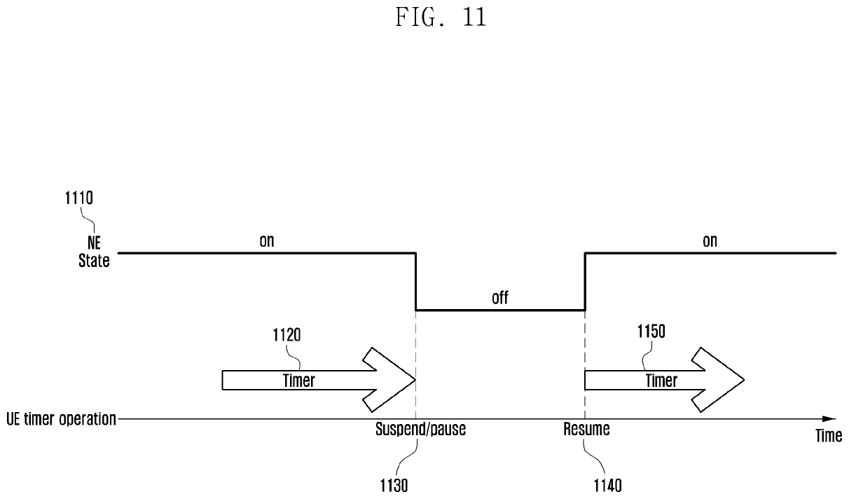

FIG. 11 is a diagram illustrating a MAC timer operation method according to an embodiment of the disclosure.

In the case of an NE OFF state in a NES mode, because the base station reduces power consumption by turning off power of the transceiver, the UE in which the NES mode is configured may also turn off power of the transceiver not to perform transmission and reception operations. In this case, if a MAC layer timer of the UE is running, continuing to run the running timer may cause inefficiency in a MAC layer operation. For example, in the case that the UE enters the NE OFF state while a bwp-InactivityTimer is running, the bwp-InactivityTimer may not be restarted because the UE does not receive scheduling from the base station in the NE OFF state. Therefore, in the case that it is difficult to have a sufficient time to satisfy the condition for restarting the bwp-Inactivity Timer after the NE OFF state is changed to the NE ON state or when the timer expires during the NE OFF state, the bwp-Inactivity Timer may expire and change a BWP to a default BWP. However, such an operation may be an unnecessary BWP change operation. In this way, because the running timer continues to run unnecessarily in the NE OFF state due to the NE OFF state, to increase the possibility of expiration of the timer is an inefficient timer operation; thus, an operation of suspending/pausing the running MAC layer timer may be required in the NE OFF state. In the embodiment of FIG. 11, it is assumed that the NE state (1110) of the UE is changed from the NE ON state to the NE OFF state (1130). In this case, if any MAC timer of the UE is running (1120), the running timer may be suspended/paused in the case of changing to the NE OFF state. Thereafter, when the NE state of the UE is changed again to the NE ON state (1140), the stopped timer may be resumed again (1150). With such an operation, the UE may prevent the possibility of expiration of the running MAC timer in the NES mode from increasing. The timer suspension and resumption operations described with reference to FIG. 11 may be applied to at least one of the following timers.
sCellDeactivation Timer
bwp-InactivityTimer
configuredGrantTimer
cg-Retransmission Timer
drx-HARQ-RTT-TimerDL
drx-HARQ-RTT-TimerUL
drx-Retransmission TimerDL
drx-Retransmission TimerUL
logicalChannelSR-DelayTimer
sr-ProhibitTimer
beamFailureRecovery Timer
drx-Inactivity Timer

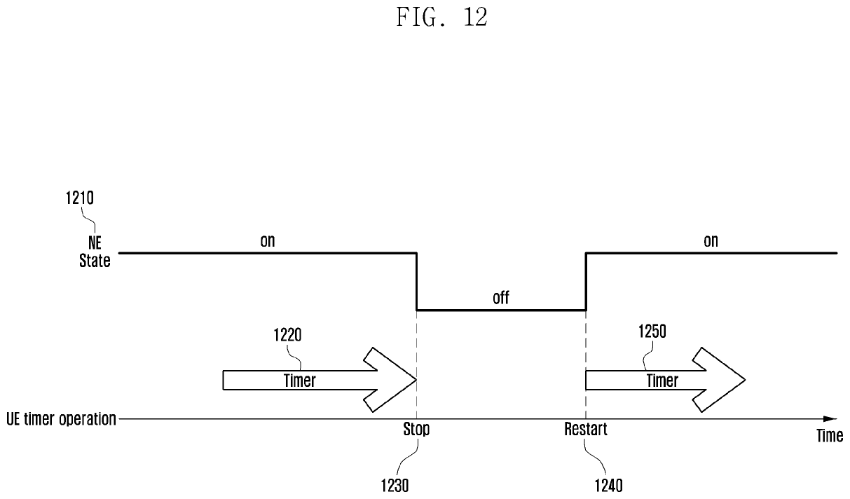

FIG. 12 is a diagram illustrating a MAC timer operation method according to an embodiment of the disclosure.

In the case of an NE OFF state in an NES mode, because the base station reduces power consumption by turning off power of the transceiver, the UE in which the NES mode is configured may also turn off power of the transceiver not to perform transmission and reception operations. In this case, if a MAC layer timer of the UE is running, continuing to run the running timer may cause inefficiency in a MAC layer operation. For example, in the case that the UE enters the NE OFF state while a bwp-InactivityTimer is running, the bwp-InactivityTimer may not be restarted because the UE does not receive scheduling from the base station in the NE OFF state. Therefore, in the case that it is difficult to have a sufficient time to satisfy the condition for restarting the bwp-Inactivity Timer after the NE OFF state is changed to the NE ON state or when the timer expires during the NE OFF state, the bwp-Inactivity Timer may expire and change a BWP to a default BWP. However, such an operation may be an unnecessary BWP change operation. In this way, because the running timer continues to operate unnecessarily in the NE OFF state due to the NE OFF state, to increase the possibility of expiration of the timer is an inefficient timer operation; thus, it may be necessary to restart the MAC layer timer when stopping the running MAC layer timer and returning to the NE ON state later in the NE OFF state. In the embodiment of FIG. 12, it is assumed that the NE state (1210) of the UE changes from the NE ON state to the NE OFF state (1230). If any MAC timer of the UE is running when the NE state (1210) of the UE is changed to the NE OFF state (1220), the running timer may be stopped in the case that the NE state (1210) of the UE is changed to the NE OFF state. Thereafter, when the NE state (1210) of the UE is changed again to the NE ON state (1240), the stopped MAC timer may be restarted (1250). With such an operation, the UE may prevent the possibility of expiration of the running MAC timer in the NES mode from increasing. The timer stop and restart operation described with reference to FIG. 12 may be applied to at least one of the following timers.
sCellDeactivation Timer
bwp-InactivityTimer
configuredGrantTimer
cg-Retransmission Timer
drx-HARQ-RTT-TimerDL
drx-HARQ-RTT-TimerUL
drx-Retransmission TimerDL
drx-Retransmission TimerUL
logicalChannelSR-DelayTimer
sr-ProhibitTimer
beamFailureRecovery Timer
drx-Inactivity Timer

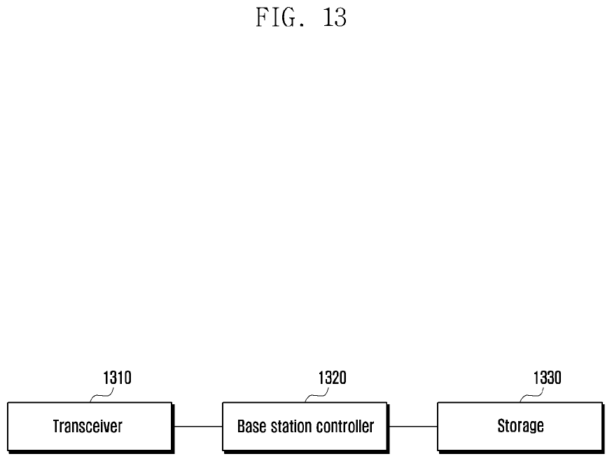

FIG. 13 is a block diagram illustrating a structure of a base station according to an embodiment of the disclosure.

With reference to FIG. 13, the base station may include a transceiver 1310, a controller 1320, and a storage 1330. The transceiver 1310, the controller 1320, and the storage 1330 may operate according to the communication method of the base station described above. Further, the network device may correspond to the structure of the base station. However, the components of the base station are not limited to the examples described above. For example, the base station may include more or fewer components than the above-described components. For example, the base station may include a transceiver 1310 and a controller 1320. Further, the transceiver 1310, the controller 1320, and the storage 1330 may be implemented in the form of a single chip.

The transceiver 1310 is a general term for the receiver of the base station and the transmitter of the base station, and may transmit and receive signals to and from an UE, another base station, or another network device. In this case, the transmitted and received signals may include control information and data. The transceiver 1310 may transmit, for example, system information to the UE, and transmit a synchronization signal or a reference signal. To this end, the transceiver 1310 may be composed of an RF transmitter for up-converting and amplifying a frequency of a signal to be transmitted, and an RF receiver for low-noise amplifying a received signal and down-converting a frequency thereof. However, this is only an embodiment of the transceiver 1310, and the components of the transceiver 1310 are not limited to the RF transmitter and the RF receiver. The transceiver 1310 may include a wired or wireless transceiver, and may include various components for transmitting and receiving signals. Further, the transceiver 1310 may receive a signal through a communication channel (e.g., wireless channel) and output the signal to the controller 1320, and transmit the signal output from the controller 1320 through the communication channel. Further, the transceiver 1310 may receive a communication signal and output the communication signal to the processor, and transmit the signal output from the processor to a UE, another base station, or another entity through a wired or wireless network.

The storage 1330 may store programs and data required for the operation of the base station. Further, the storage 1330 may store control information or data included in a signal acquired from the base station. The storage 1330 may be composed of storage media such as a ROM, a RAM, a hard disk, a CD-ROM, and a DVD or a combination of storage media. Further, the storage 1330 may store at least one of information transmitted and received through the transceiver 1310 or information generated through the controller 1320.

In the disclosure, the controller 1320 may be defined to a circuit, an application specific integrated circuit, or at least one processor. The processor may include a communication processor (CP) that performs the control for communication and an application processor (AP) that controls upper layers such as an application program. The controller 1320 may control the overall operation of the base station according to the embodiment proposed in the disclosure. For example, the controller 1320 may control the signal flow between each block to perform an operation according to the flowchart described above. According to an embodiment, the controller 1320 may control the transceiver 1310 to transmit a message for configuring a network energy saving (NES) operation for reducing power for a network to a plurality of UEs in a group transmission manner, and to transmit a MAC CE including bitmap information indicating whether a network energy (NE) state is on/off based on the NES operation.

The group transmission manner may be a manner based on system information or based on a radio network temporary identifier (RNTI) configured to the plurality of UEs.

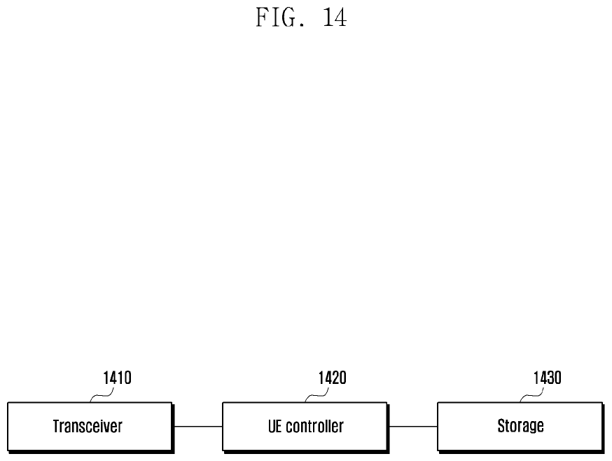

FIG. 14 is a block diagram illustrating a structure of a UE according to an embodiment of the disclosure.

With reference to FIG. 14, the UE may include a transceiver 1410, a controller 1420, and a storage 1430. The transceiver 1410, the controller 1420, and the storage 1430 may operate according to the communication method of the UE described above. However, the components of the UE are not limited to the above-described examples. For example, the UE may include more or fewer components than the above-described components. For example, the UE may include a transceiver 1410 and a controller 1420. Further, the transceiver 1410, the controller 1420, and the storage 1430 may be implemented in the form of a single chip.

The transceiver 1410 is a general term for the receiver of the UE and the transmitter of the UE, and may transmit and receive signals to and from a base station, another UE, or a network entity. The signals transmitted and received to and from the base station may include control information and data. The transceiver 1410 may receive, for example, system information from the base station, and receive a synchronization signal or a reference signal. To this end, the transceiver 1410 may be composed of an RF transmitter for up-converting and amplifying a frequency of a signal to be transmitted, and an RF receiver for low-noise amplifying a received signal and down-converting a frequency thereof. However, this is only an embodiment of the transceiver 1410, and the components of the transceiver 1410 are not limited to the RF transmitter and the RF receiver. Further, the transceiver 1410 may include a wired or wireless transceiver, and include various components for transmitting and receiving signals. Further, the transceiver 1410 may receive a signal through a wireless channel and output the signal to the controller 1420, and transmit the signal output from the controller 1420 through the wireless channel. Further, the transceiver 1410 may receive a communication signal and output the communication signal to the processor, and transmit the signal output from the processor to a network entity through a wired or wireless network.

The storage 1430 may store programs and data required for the operation of the UE. Further, the memory 1430 may store control information or data included in a signal acquired from the UE. The storage 1430 may be composed of storage media such as a ROM, a RAM, a hard disk, a CD-ROM, and a DVD, or a combination of storage media.

In the disclosure, the controller 1420 may be defined to a circuit, an application specific integrated circuit, or at least one processor. The processor may include a communication processor (CP) that performs the control for communication and an application processor (AP) that controls upper layers such as an application program. The controller 1420 may control the overall operation of the UE according to the embodiment proposed in the disclosure. For example, the controller 1420 may control the signal flow between each block to perform an operation according to the flowchart described above. According to an embodiment, the controller 1420 may control to identify whether a network energy saving (NES) operation for reducing power for the network and a discontinuous reception (DRX) operation for reducing power of the UE are configured, to determine whether a network energy (NE) state is on/off based on the NES operation in the case that both the NES operation and the DRX operation are configured to the UE, and to determine that DRX is in an inactive duration based on the DRX operation in the case that the NE state is off.

The controller 1420 may control to determine whether DRX is in an active/inactive duration based on the DRX operation in the case that the NE state is on, to perform an operation corresponding to the DRX active duration if the controller 1420 determines that DRX is in an active duration, and to perform an operation corresponding to the DRX inactive duration if the controller 1420 determines that DRX is in an inactive duration. For example, the controller 1420 may control to perform PDCCH monitoring if the controller 1420 determines that DRX is in an active duration, and not to perform PDCCH monitoring if the controller 1420 determines that DRX is in an inactive duration.

The controller 1420 may control to identify whether the NES operation is configured based on a message transmitted in a group transmission manner for configuring the NES operation to a plurality of UEs.

Further, the group transmission manner may be characterized as being based on system information or based on a radio network temporary identifier (RNTI) configured to the plurality of UEs.

Whether the NE state is on/off may be indicated by bitmap information using a MAC CE.

Methods according to the embodiments described in the claims or specifications of the disclosure may be implemented in the form of hardware, software, or a combination of hardware and software.

In the case of being implemented in software, a computer readable storage medium storing one or more programs (software modules) may be provided. One or more programs stored in the computer readable storage medium are configured for execution by one or more processors in an electronic device. The one or more programs include instructions for causing the electronic device to execute methods according to embodiments described in a claim or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), any other form of optical storage device, or a magnetic cassette. Alternatively, the programs may be stored in a memory composed of a combination of some or all thereof. Further, each constitution memory may be included in the plural.

Further, the program may be stored in an attachable storage device that may access through a communication network such as the Internet, Intranet, local area network (LAN), wide LAN (WLAN), or storage area Network (SAN), or a communication network composed of a combination thereof. Such a storage device may access a device implementing an embodiment of the disclosure through an external port. Further, a separate storage device on a communication network may access a device implementing the embodiment of the disclosure.

In the specific embodiments of the disclosure described above, components included in the disclosure are expressed in the singular or plural according to the presented specific embodiments. However, the singular or plural expression is appropriately selected for a situation presented for convenience of description, and the disclosure is not limited to the singular or plural components, and even if a component is represented in the plural, it may be composed of the singular, or even if a component is represented in the singular, it may be composed of the plural.

In the detailed description of the disclosure, although specific embodiments have been described, various modifications are possible without departing from the scope of the disclosure. Therefore, the scope of the disclosure should not be limited to the described embodiments and should be defined by the claims described below as well as equivalents to the claims.

1-15. (canceled)

16. A method performed by a terminal in a wireless communication system, the method comprising:
receiving, from a base station, a control message including information for configuring at least one of an energy saving operation for a network or a discontinuous reception (DRX) operation;
identifying that the energy saving operation for the network is configured based on the information; and
identifying whether the DRX operation is configured based on the information,
wherein a physical downlink control channel (PDCCH) monitoring is not performed regardless of that the DRX operation is configured during a duration for an energy saving for the network based on the energy saving operation for the network.

17. The method of claim 16, wherein a reception of a configured downlink semi-persistent scheduling (SPS) transmission is not performed during the duration for the energy saving for the network based on the energy saving operation for the network.

18. The method of claim 16, wherein a scheduling request (SR) transmission is not performed during a non-active time based on the DRX operation.

19. The method of claim 16, wherein a channel state information (CSI) is not reported during a non-active time based on the DRX operation.

20. The method of claim 16, wherein a transmission associated with a configured uplink grant is not performed during a non-active time based on the DRX operation.

21. A method performed by a base station in a wireless communication system, the method comprising:
transmitting, to a terminal, a control message including information for configuring at least one of an energy saving operation for a network or a discontinuous reception (DRX) operation; and
transmitting a medium access control (MAC) control element (CE) including bitmap information indicating whether a duration for an energy saving for the network based on the energy saving operation for the network,
wherein a physical downlink control channel (PDCCH) monitoring is not performed, by the terminal, regardless of that the DRX operation is configured during the duration for the energy saving for the network based on the energy saving operation for the network.

22. The method of claim 21, wherein a reception of a configured downlink semi-persistent scheduling (SPS) transmission is not performed during the duration for the energy saving for the network based on the energy saving operation for the network

23. A terminal in a wireless communication system, the terminal comprising:
a transceiver; and
at least one processor configured to control to:
receive, from a base station via the transceiver, a control message including information for configuring at least one of an energy saving operation for a network or a discontinuous reception (DRX) operation,
identify that the energy saving operation for the network is configured based on the information, and
identify whether the DRX operation is configured based on the information,
wherein a physical downlink control channel (PDCCH) monitoring is not performed regardless of that the DRX operation is configured during a duration for an energy saving for the network based on the energy saving operation for the network.

24. The terminal of claim 23, wherein a reception of a configured downlink semi-persistent scheduling (SPS) transmission is not performed during the duration for the energy saving for the network based on the energy saving operation for the network.

25. The terminal of claim 23, wherein a scheduling request (SR) transmission is not performed during a non-active time based on the DRX operation.

26. The terminal of claim 23, wherein a channel state information (CSI) is not reported during a non-active time based on the DRX operation.

27. The terminal of claim 23, wherein a transmission associated with a configured uplink grant is not performed during a non-active time based on the DRX operation.

28. A base station in a wireless communication system, the base station comprising:
a transceiver; and
at least one processor configured to:
transmit, to a terminal via the transceiver, a control message including information for configuring at least one of an energy saving operation for a network or a discontinuous reception (DRX) operation, and
transmit, to the terminal via the transceiver, a medium access control (MAC) control element (CE) including bitmap information indicating whether a duration for an energy saving for the network based on the energy saving operation for the network,
wherein a physical downlink control channel (PDCCH) monitoring is not performed, by the terminal, regardless of that the DRX operation is configured during the duration for the energy saving for the network based on the energy saving operation for the network.

29. The base station of claim 28, wherein a reception of a configured downlink semi-persistent scheduling (SPS) transmission is not performed during the duration for the energy saving for the network based on the energy saving operation for the network.
